(19) United States
(12) Patent Application Publication
(10) Pub. No.: US 2019/0308624 A1
(43) Pub. Date: Oct. 10, 2019

(54) INTELLIGENT ADAPTIVE CRUISE CONTROL FOR PLATOONING

(71) Applicant: Cummins Inc., Columbus, IN (US)

(72) Inventors: Hoseinali Borhan, Bloomington, IN (US); Timothy R. Frazier, Columbus, IN (US)

(21) Appl. No.: 16/374,165

(22) Filed: Apr. 3, 2019

Related U.S. Application Data
(60) Provisional application No. 62/652,523, filed on Apr. 4, 2018.

(51) Int. Cl. B60W 30/16

(52) U.S. Cl. CPC B60W 30/16; B60W 2550/142; B60W 2720/10; B60W 2750/308; B60W 2550/308

(57) ABSTRACT

Adaptive cruise control apparatuses, methods, and system are disclosed. In one embodiment, an electronic control system of a following vehicle detects a preceding vehicle, the following vehicle is controlled to follow the preceding vehicle at an initial following distance, the initial following distance is perturbated, and the following distance is modified if the perturbated following distance offers a fuel or energy benefit.

### CROSS REFERENCE

The present application claims the benefit of and priority to U.S. Application No. 62/652,523 filed Apr. 4, 2018, the disclosure of which is hereby incorporated by reference.

### GOVERNMENT RIGHTS

This invention was made with government support under DE-AR0000793 awarded by Advanced Research Projects Agency-Energy (ARPA-E). The government has certain rights in the invention.

### BACKGROUND

The present application relates generally to apparatuses, controls, methods, systems, and techniques utilizing intelligent adaptive cruise control (hereinafter sometimes referred to as ACC) for vehicle platooning. Vehicle platooning generally refers to the operation of two or more vehicles to provide a desired inter-vehicle distance or positioning. Vehicle platooning may significantly reduce fuel consumption by reducing the aerodynamic drag losses. Conventional vehicle platooning controls rely upon inter-vehicle communication in order to determine whether and when to enter into a platooning operating mode, what inter-vehicle distance or positioning is safe and what inter-vehicle distance or positioning will provide a desired benefit of reduced fuel consumption. As a practical matter, the complexity and computational cost of such controls require a separate platooning control unit or other forms of additional control hardware. Additionally, such controls require a highly reliable vehicle-to-vehicle (V2V) communication necessitating still more additional control hardware. In view of these and other unaddressed shortcomings, there remains a significant need for the unique apparatuses, controls, methods, systems, and techniques disclosed herein.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY OF THE DISCLOSURE

Exemplary embodiments include unique apparatuses, controls, methods, systems and techniques utilizing intelligent adaptive cruise control for vehicle platooning or vehicle drafting. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an exemplary vehicle system.

FIG. 2 is a schematic diagram illustrating certain aspects of an exemplary vehicle controller.

FIG. 3 is a schematic diagram illustrating an exemplary ACC vehicle control process.

FIG. 4A-4E are schematic diagrams illustrating exemplary operation of a following vehicle relative to a preceding vehicle.

FIG. 5A-5E are schematic diagrams illustrating exemplary operation of a following vehicle relative to a preceding vehicle.

### DETAILED DESCRIPTION OF ILLUSTRATIVE EMBODIMENTS

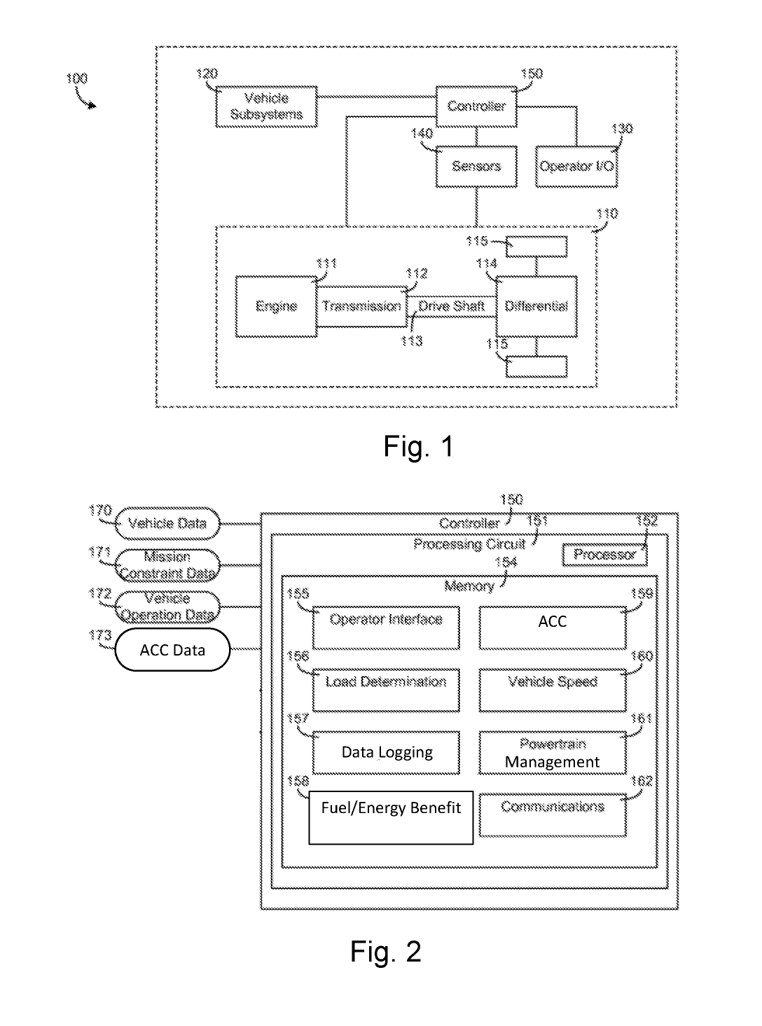

With reference to FIG. 1, there is illustrated a schematic diagram of an exemplary vehicle system 100 including a controller 150. The vehicle system 100 may be an on-road or an off-road vehicle including, but not limited to, work machines, line-haul trucks, mid-range trucks (e.g., pick-up truck), passenger vehicles (e.g., sedans, coupes, compacts, sport utility vehicles), or any other type of vehicle that utilizes cruise control systems. Although FIG. 1 depicts the vehicle system 100 as including an internal combustion engine 111, the vehicle system 100 may be powered by any a variety of types of prime mover. For example, in certain embodiments, the vehicle system 100 may be configured as a hybrid electric vehicle in which the prime mover includes an internal combustion engine and one or more electric motors. In such embodiments, the prime mover may be selectably powered by controlled combustion of fuel by the engine and/or controlled provision of electric power by an energy storage system, such as a battery, via power electronics such as one or more power converters or inverters. In certain embodiments, the vehicle system 100 may be a fully electric vehicle in which the prime mover comprises one or more electric motors. In such embodiments, the prime mover may be powered by controlled provision of electric power by an energy storage system, such as a battery, via power electronics such as a power converter or inverter.

The vehicle system 100 generally includes a powertrain system 110, vehicle subsystems 120, an operator input/output (I/O) device 130, and sensors 140 that are all communicably coupled to the controller 150. Communication between and among the components of the vehicle system 100 may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 150 is communicably coupled to the systems and components in the vehicle system 100 of FIG. 1, the controller 150 is structured to receive/interpret data from one or more of the components illustrated in FIG. 1. For example, the data may include road data (e.g., road grade, road type, road loads, road curvature, etc.) and surrounding vehicle proximity data received via one or more sensors, such as sensors 140 and indicating the presence, distance, and/or location of physical objects external to vehicle system 100. The data may also provide operational data of vehicle system 100 such as powertrain data (e.g., engine or other prime mover data or transmission data), accessory data, or braking system data to name several examples. The controller 150 may utilize this data to adjust an ACC set speed to provide platooning operation effective to increase fuel or and/or energy efficiency or reduce fuel and/or energy consumption without requiring coordination with or communication from or with any other vehicle such as a preceding vehicle behind which vehicle system 100 is drafting.

The powertrain system 110 includes an engine 111, a transmission 112, a drive shaft 113, a differential 114, and a final drive 115. The engine 111 receives a chemical energy input (e.g., a fuel such as gasoline, diesel, etc.) and combusts the fuel to generate mechanical energy, in the form of a rotating crankshaft. The transmission 112 receives the rotating crankshaft and manipulates the speed of the crankshaft to affect a desired drive shaft 113 speed. The rotating drive shaft 113 is received by a differential 114, which provides the rotation energy of the drive shaft 113 to the final drive 115. The final drive 115 then propels or moves the vehicle system 100.

The engine 111 may be structured as any engine type: from an internal combustion engine to a full electric motor and combinations/variations in between (e.g., a hybrid drive comprising an internal combustion engine and an electric motor). According to the example embodiment, the engine 111 is structured as an internal combustion engine (e.g., compression-ignition, spark-ignition, etc.) that may be powered by any fuel type (e.g., diesel, ethanol, gasoline, etc.). Similarly, the transmission 112 may be structured as any type of transmission, such as a continuous variable transmission, a manual transmission, an automatic transmission, an automatic-manual transmission, a dual clutch transmission, etc. Accordingly, as transmissions vary from geared to continuous configurations (e.g., continuously variable transmission, etc.), the transmission can include a variety of settings (gears, for a geared transmission) that affect different output speeds based on the engine speed. Like the engine 111 and the transmission 112, the drive shaft 113, the differential 114, and the final drive 115 may be structured in any configuration dependent on the application (e.g., the final drive 115 is structured as wheels in an automotive application and a propeller in an airplane application, etc.). Further, the drive shaft 113 may be structured as any type of drive shaft including, but not limited to, a one-piece, two-piece, and a slip-in-tube driveshaft based on the application.

The vehicle system 100 also includes vehicle subsystems 120. The vehicle subsystems 120 may include both electrically-powered vehicle accessories and engine driven vehicle accessories, as well as any other type of subsystem in the vehicle system 100. For example, a subsystem may include an exhaust aftertreatment system. The exhaust aftertreatment system may include any component used to reduce exhaust emissions (e.g., diesel exhaust emissions, gas exhaust emissions, etc.), such as selective catalytic reduction catalyst, a diesel oxidation catalyst, a diesel particulate filter, a diesel exhaust fluid doser with a supply of diesel exhaust fluid, and a plurality of sensors for monitoring the aftertreatment system (e.g., a NOx sensor, etc.). The accessories may include, but are not limited to, air compressors (for pneumatic devices), air conditioning systems, power steering pumps, engine coolant pumps, fans, and the like.

The operator I/O device 130 enables an operator of the vehicle system 100 (or another passenger) to communicate with the vehicle system 100 and controller 150. For example, the operator I/O device 130 may include, but is not limited to an interactive display, a touchscreen device, one or more buttons or switches, voice command receivers, etc. In this regard, the device 130 may be structured as solely an output device, where the signals, values, messages, information, etc. may only be provided to an operator or passenger of the vehicle; solely as input device, where an operator or passenger may provide information, signals, messages, etc. to the controller 150; and/or a combination therewith like shown in the example of FIG. 1. Via the operator I/O device 130, the user may input a desired operating characteristic including, but not limited to: minimize fuel consumption; minimize trip time; minimize power consumption; limit power output; and the like. In regard to a cruise control operating mode, the controller 150 may selectively adjust one or more cruise control characteristics to accommodate the inputted preference. This is explained more fully in regard to FIG. 2.

As the components of FIG. 1 are illustrated to be embodied in a vehicle system 100, the controller 150 may be provided as one or more electronic control units (ECU), sometimes referred to as electronic control modules (ECM). The one or more ECU may include powertrain controls, transmission controls and any other vehicle controls (e.g., exhaust aftertreatment control unit, powertrain control unit, engine control unit, etc.). The function and structure of an exemplary embodiment of the controller 150 are described in greater detail in FIG. 2.

As such, referring now to FIG. 2, the function and structure of the controller 150 are illustrated according to one embodiment. The controller 150 is illustrated to include a processing circuit 151 including a processor 152 and a memory 154. The processor 152 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 154 (e.g., RAM, ROM, Flash Memory, hard disk storage, etc.) may store data and/or computer code for facilitating the various processes described herein. Thus, the one or more memory devices 154 may be communicably connected to the processor 152 and provide computer code or instructions to the processor 152 for executing the processes described in regard to the controller 150 herein. Moreover, the one or more memory devices 154 may be or include tangible, non-transient volatile memory or non-volatile memory. Accordingly, the one or more memory devices 154 may include database components, object code components, script components, or any other type of information structure for supporting the various activities and information structures described herein.

The memory 154 is a non-transitory memory structured to store various blocks of executable instructions for completing the activities described herein. More particularly, the memory 154 includes executable instruction blocks configured to selectively adjust one or more cruise control parameters of a vehicle. The constituent memory locations of blocks of executable instructions may be physically grouped or distributed as well as logically grouped or distributed. While various executable instruction blocks with particular functionality are illustrated in FIG. 2, it should be understood that the controller 150 and memory 154 may include other numbers or configurations of executable instruction blocks for executing the functions described herein. For example, the activities of multiple blocks may be combined as a single block, as additional modules with additional functionality may be included, etc. Further, it should be understood that controller 150 may further control other vehicle activity beyond the scope of the present disclosure.

Certain operations of the controller 150 described herein include operations to interpret and/or to determine one or more parameters. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient controller-readable storage medium, receiving the value as a run-time parameter by any means known in the art, and/or by receiving a value by which the interpreted parameter can be calculated, and/or by referencing a default value that is interpreted to be the parameter value.

As illustrated in FIG. 2, the controller 150 may include an operator interface block 155, a load determination block 156, a data logging block 157, a fuel/energy benefit determination block 158 which is structured to evaluate whether an adjustment of one or more ACC parameters provides a benefit of reduced fuel or energy consumption or increase fuel or energy efficiency, and an ACC block 159 which is structured to control one or more of vehicle velocity, acceleration, distance and positioning parameters relative to one or more other vehicles such as a preceding vehicle. Controller 150 may further include a vehicle speed management block 160 which is structured to control vehicle speed, a powertrain management block 161 which is structured to control operation of powertrain components such as engine 111 or other prime mover components, and a communications block 162 which, in some forms, may be structured to provide only intra-vehicle communication capabilities and, in other forms, may provide inter-vehicle communication capabilities or vehicle to X (V2X) communication capabilities.

The operator interface block 155 may be communicably coupled to the operator I/O device 130 and is structured to receive one or more inputs from an operator, passenger, or another user of the vehicle system 100. The input may include an ACC operator set speed, an ACC operator initiation, etc. Operator adjustments to the ACC set speed may also be received as an input. Similarly, the input may include an operator deactivation of ACC. As an example, an operator may activate ACC and input an ACC operator set speed. The ACC block 159 may then further modify the ACC set speed to deviate from the ACC operator set speed in order to control distance and positioning parameters relative to one or more other vehicles such as a preceding vehicle. The input may further include mission constraint data 171 which may include a constraint and/or a preference of regarding operation of the vehicle system 100.

Various vehicle data 170 may also be received via the operator interface block 155 and/or otherwise stored in the memory 154. The vehicle data 170 may be used by the load determination block 156 and may generally include a vehicle mass, vehicle aerodynamic coefficient, tire dynamic rolling resistance, tire static rolling resistance, tire circumference, radius or diameter, a lookup table for a final drive torque loss, a lookup table for a transmission torque loss, and a lookup table for an engine torque loss. As may be discerned from the types of vehicle data 170 described above, the vehicle data 170 may be predefined in the controller 150 (e.g., vehicle mass) to take into consideration constants for the vehicle. As the controller 150 of the present disclosure may be used with other vehicles, an operator may simply download or select the vehicle (e.g., from a drop-down menu) that will use the controller 150 to populate or receive the vehicle data 170 specific to that vehicle.

The load determination block 156 is structured to determine a current road load for the vehicle based at least partially on the vehicle data 170 and vehicle operation data 172 (described below) while the vehicle is in the ACC operating mode. The current road load is the load that the engine/vehicle overcomes to maintain or substantially maintain the ACC set speed. In some embodiments, the vehicle speed management block 160 implements adjustments to the ACC set speed to accommodate for future road loads, as is described more fully herein. In other embodiments, the vehicle speed management block 160 substantially prevents adjustments that may adversely impact operability of the vehicle system 100 and/or one or more of the operator's preferences (e.g., minimize fuel consumption, etc.).

To determine the current road load on the vehicle system 100, the load determination block 156 may interpret vehicle operation data 172 acquired by one or more sensors in the vehicle system 100, such as sensors 140. The sensors 140 may include, but are not limited to: engine speed sensors; vehicle speed sensors; engine torque sensors; vehicle mass sensors; road grade measurement sensors (e.g., an inclinometer); and the like. The sensors 140 may also include sensors configured to provide proximity data indicating the presence, distance, and/or location of physical objects external to vehicle system 100, for example, proximity sensors or proximity sensor systems, image sensors or image sensor systems, ultrasonic sensors or ultrasonic sensor systems, microwave sensors or microwave sensor systems, magnetometer sensors or magnetometer sensor systems, optical sensors or optical sensor systems, infrared sensors or infrared sensor systems, LIDAR sensors or LIDAR sensor systems, RADAR sensors or RADAR sensor systems, and/or other types of sensor or sensor systems operable to provide data indicating the presence and/or location of physical objects external to vehicle system 100 which may be referred to herein, individually, in combination or collectively, as “vehicle environment sensors”). Accordingly, the vehicle operation data 172 includes data regarding a characteristic of the operation of the vehicle system 100. The vehicle operation data 172 may include operation characteristics such as, but not limited to, an engine speed, a vehicle speed, an engine torque, an aerodynamic drag, component efficiencies (e.g., engine efficiency, transmission efficiency, etc.), a current road grade, etc. In certain embodiments, the load determination block 156 may determine the current road load based on the vehicle operation data 172 and the vehicle data 170 described above (e.g., vehicle mass, rolling resistance, etc.). In other embodiments, the current road load may be directly measured without the use of vehicle operation data 172 and/or vehicle data (e.g., via a load sensor, etc.). All such variations and methods are intended to be within the scope and spirit of the present disclosure. The load determination block 156 is structured to transmit the current road load for the vehicle system 100 to the vehicle speed management block 160.

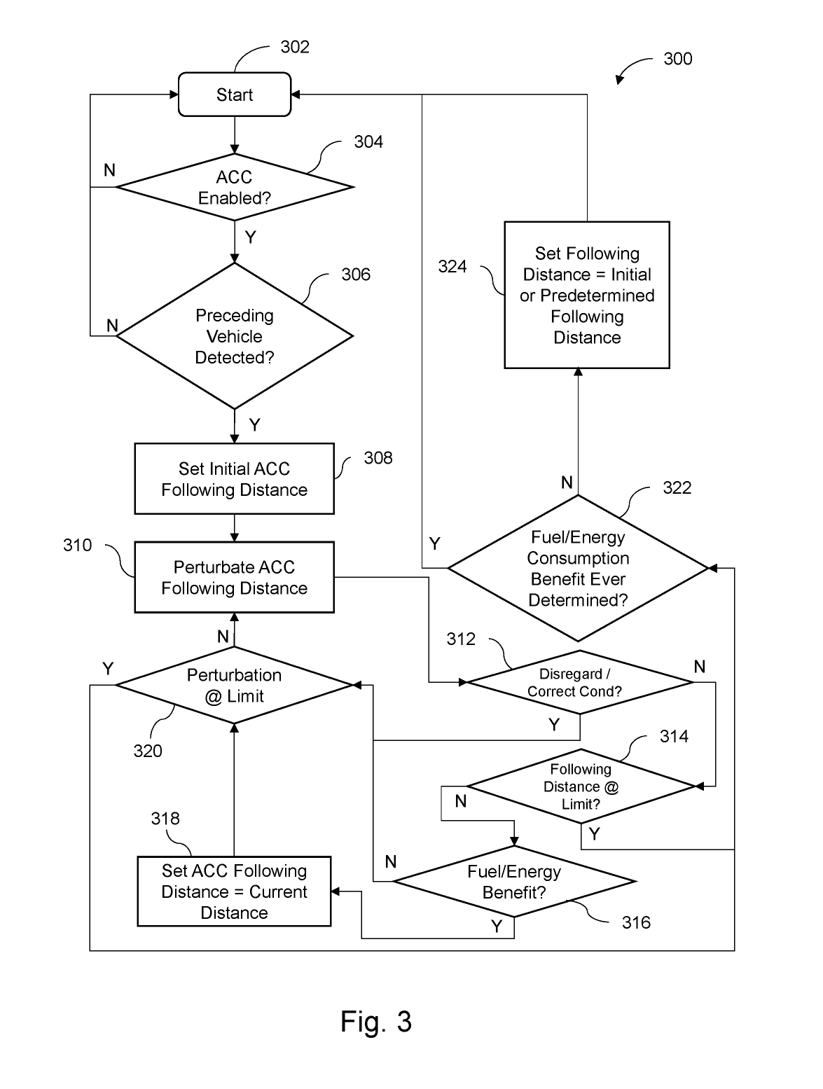

With reference to FIG. 3 there is illustrated a flow diagram according to an exemplary ACC vehicle control process. Process 300 is an exemplary ACC process, which may be performed by one or more controllers of the vehicle system 100 described above, such as vehicle controller 150 and/or other controllers. Process 300 begins at start operation 302 and proceeds to conditional 304 which determines if ACC operation is enabled. Conditional 304 may use a number of techniques to determine if ACC is enabled. In certain forms conditional 304 may determine if ACC is enabled by checking a memory location linked to an ACC enable input. If ACC is not enabled, the process returns to start operation 302. If ACC is enabled, process 300 proceeds from conditional 304 to conditional 306.

Conditional 306 determines if a preceding vehicle is detected. Detecting a preceding vehicle in the proximity may use input from one or more vehicle environment sensors, for example, one or more of the systems or systems described elsewhere herein. In certain forms, conditional 306 may determine if a preceding vehicle is in sufficient proximity to permit platooning or drafting operation. This determination may be made without using any communication or information sent from the preceding vehicle. If a preceding vehicle is not detected, then process 300 returns to start operation 302. If a preceding vehicle is detected, then process 300 proceeds from conditional 306 to operation 308.

Operation 308 sets an initial ACC following distance, which may be defined as the inter-vehicle distance between a vehicle system executing process 300 and a preceding vehicle. The initial following distance may be determined as a following distance greater than a minimum safe following distance. The minimum safe following distance may be determined based on the information provided by one or more sensors or systems of the vehicle executing process 300, for example, one or more vehicle environment sensors or systems, one or more vehicle parameters (e.g., vehicle mass), one or more vehicle environmental sensor inputs (e.g., temperature, road grade etc.) and one or more vehicle operating parameters (e.g., vehicle speed, acceleration, etc.). Once the initial ACC following distance is set, process 300 may control the vehicle to follow the preceding vehicle at the initial ACC target following distance. Process 300 proceeds from operation 308 to operation 310.

Operation 310 perturbates the ACC following distance. The perturbation may include decreasing the ACC following distance by a predetermined amount, a dynamically determined amount or a randomly or pseudo-randomly determined amount subject to certain constraints such as safety constraints or a maximum perturbation magnitude constraint. In certain forms operation 310 may use an identification procedure to adjust the ACC target following distance to a perturbated following distance. An identification procedure may involve a safe perturbation in the desired distance if a set of operational and safety conditions are satisfied. The perturbation and determining processes may be repeated with a timing or frequency sufficient to mitigate the effect of confounding variables on the vehicle response to the perturbation (e.g., changes in road grade, wind speed, wind direction, temperature, road conditions or other variables that could impact the fuel or energy consumption or efficiency). In certain forms, the timing or frequency may comprise repeating the perturbation every 5 seconds, every 2 seconds, or less. Process 300 proceeds from operation 310 to conditional 312.

Conditional 312 determines if a disregard or correct condition is present. The disregard or correct condition may provide an indication that the effect of one or more confounding variables is sufficiently great to warrant either disregarding or correcting a subsequent assessment of the impact on fuel or energy consumption or efficiency. In certain forms, the disregard or correct condition may include and evaluate a change in road grade relative to a limit. In certain forms, the disregard or correct condition may include and evaluate a change in one or more vehicle operating parameters relative to one or more respective limits, for example, engine speed, gear selection, service brake operation, engine braking operation or other vehicle operating parameters. In certain forms, the disregard or correct condition may include and evaluate combinations of two or more of the foregoing or other potential confounding variables. If the disregard or correct condition is not present, process 300 proceeds from conditional 312 to conditional 314. If the disregard or correct condition is present, process 300 proceeds from conditional 312 to conditional 320.

Conditional 314 determines if the ACC following distance has reached a limit, e.g., a minimum safe following distance. This evaluation may be based on the information provided by one or more systems of the vehicle executing process 300, for example, one or more vehicle environment sensors or systems, one or more vehicle parameters (e.g., vehicle mass), one or more vehicle environmental sensor inputs (e.g., temperature, road grade etc.) and one or more vehicle operating parameters (e.g., vehicle speed, acceleration, etc.). If the ACC following distance is not at the limit, process 300 proceeds from conditional 314 to conditional 316. If the ACC following distance is at the limit, process 300 proceeds from conditional 314 to conditional 322.

Conditional 316 determines if there is a fuel or energy benefit (e.g. a reduction in fuel or energy consumption or an improvement in fuel or energy efficiency). The fuel or energy benefit may be determined by comparing the average rate of change of one or more fuel or energy parameters (e.g., fuel or energy consumption or fuel or energy efficiency) at the current distance to a preceding vehicle versus a prior distance from the preceding vehicle. The fuel or energy parameter(s) may be determined based on the operational parameters of a prime mover of the vehicle system performing process 300, for example, fuel volume, fuel mass, current discharge, power discharge other parameters. A variety of adaptive control or machine learning methods can be performed in connection with conditional 316. Certain embodiments may determine and compare a fuel/energy consumption or efficiency index which can be based upon raw fuel or energy consumption information or normalized fuel or energy consumption information at the current position from the preceding vehicle by averaging multiple sample data at the current state. Where normalized index parameters are used, the normalization may be performed relative to various factors including relative to current vehicle speed or brake specific fuel consumption. If there is not a fuel/energy benefit process 316 proceeds to conditional 320. If there is a fuel/energy benefit process 300 proceeds to operation 318.

Operation 318 sets ACC following distance equal to the perturbated following distance which may be the actual current following distance, the currently value of a control command for the ACC following distance, or a proxy for either value. It shall be appreciated that these values will generally correspond but may deviate somewhat depending on the control response of the system. Thus, if the perturbated following distance has been determined to offer a fuel consumption and/or energy efficiency benefit, the process sets the ACC target following distance to the perturbated following distance. Process 300 proceeds from operation 318 to conditional 320.

Conditional 320 determines if the perturbation process is at its limit. The perturbation limit may include and evaluate a maximum number of perturbation operations that are permitted, a maximum time, a minimum additional fuel or energy benefit that has been determined, and/or other limits on the perturbation operation. The perturbation process may repeat the perturbation and determining processes until one of a following distance limit and a perturbation limit is reached. If perturbation is not at its limit, process 300 proceeds from conditional 320 to operation 310. If perturbation is at its limit, process 300 proceeds from conditional 320 to conditional 322.

Conditional 322 determines if fuel consumption and/or energy efficiency benefits were ever determined. For example, if a following distance limit or a perturbation limit were reached, the process evaluates whether a fuel consumption or energy efficiency benefit had also been determined. If determination of a fuel consumption or energy efficiency benefit had not occurred yet, process 300 proceeds from conditional 322 to operation 324. If determination of a fuel consumption or energy efficiency benefit has occurred process 300 proceed from conditional 322 to start operation 302.

Operation 324 sets the following distance equal to one of the initial ACC following distance and a predetermined ACC following distance which may be greater or less than that the initial ACC following distance. Process 300 proceeds from operation 324 to start operation 302.

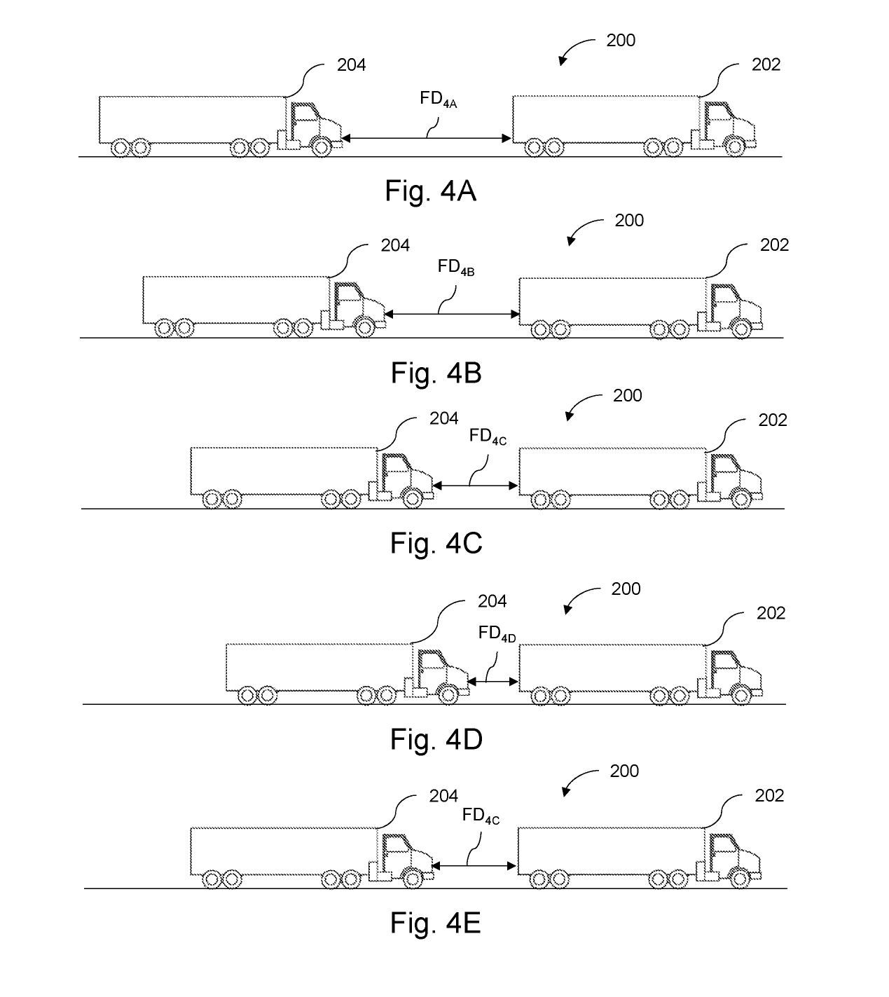

With reference to FIGS. 4A-4E which illustrates an exemplary vehicle drafting operation 200 which uses an ACC process such as process 300 described above in connection with in FIG. 3. Platooning or drafting operation includes a preceding vehicle 202 and a following vehicle 204 at various following distances: FD_{4A}, FD_{4b}, FD_{4c}, and FD_{4D}. An ACC system may adjust the desired distance between the vehicles automatically to detect and maximize drafting benefits without any need for communication between vehicles. The exemplary platooning or drafting operation illustrates two vehicles 202, 204 of the same general type where the following vehicle 204 moves toward the preceding vehicle 202 until the process determines that there is no longer any benefit to moving toward the preceding vehicle 202. Then the following vehicle 214 may return to the last distance determined to provide a fuel or energy benefit.

With reference to FIG. 4A, the following vehicle 204 is following the preceding vehicle 202 with the ACC following distance set to distance FD_{4A}. The ACC following distance is perturbated to the distance FD_{4B} illustrated in FIG. 4B. At the following distance FD_{4B}, a fuel or energy benefit evaluation is performed and, in this example, indicates a fuel or energy benefit has been provided by the following distance FD_{4B}. One or more safety or operational limit evaluations may also be performed and, in this example, have not been reached or exceeded. In response to a determination of a fuel or energy benefit and a determination of no safety or operational limit being reached or exceeded, the ACC following distance is modified to the following distance FD_{4B}.

At the following distance FD_{4B}, the perturbation process is repeated to provide following distance FD_{4C} illustrated in FIG. 4C. At the following distance FD_{4C} a fuel or energy benefit evaluation is again performed and, in this example, indicates a fuel or energy benefit has been provided by the following distance FD_{4C}. One or more safety or operational limit evaluations may also be performed and, in this example, have not been reached or exceeded. In response to a determination of a fuel or energy benefit and a determination of no safety or operational limit being reached or exceeded, the ACC following distance is modified to the following distance FD_{4C}.

At the following distance FD_{4C}, the perturbation process is repeated to provide following distance FD_{4D} illustrated in FIG. 4D. At the following distance FD_{4D} a fuel or energy benefit evaluation is again performed and, in this example, indicates a fuel or energy benefit has not been provided by the following distance FD_{4D}. In response to this determination, the ACC following distance is modified to return to the following distance FD_{4C} which is the following distance identified as providing the greatest fuel or energy benefit.

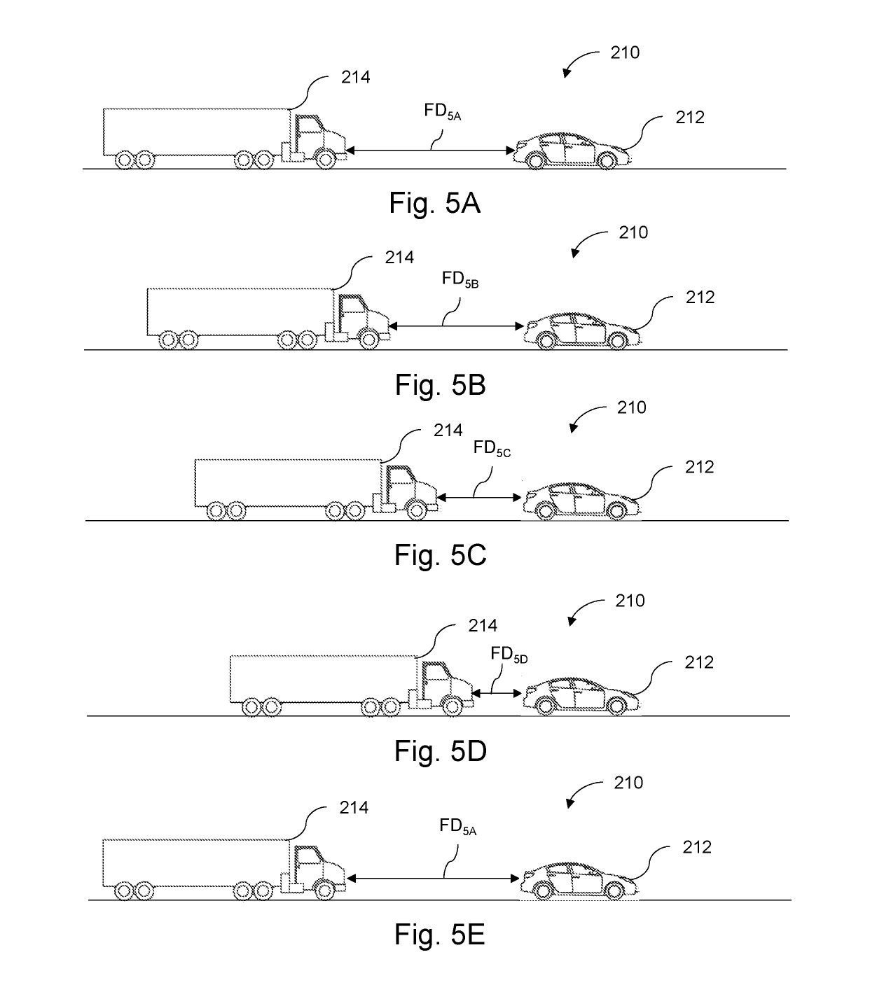

With reference to FIGS. 5A-5E which illustrates an exemplary vehicle drafting operation 210 which uses an ACC process such as process 300, described above in connection with in FIG. 3. Platooning or drafting operation includes a preceding vehicle 212 and a following vehicle 214 at various following distances: FD_{5A}, FD_{5B}, FD_{5C}, and FD_{5D}. An ACC system may adjust the desired distance between the vehicles automatically to detect and maximize drafting benefits without any need for communication between vehicles. The exemplary platooning or drafting operation illustrates two vehicles 212, 214 of different types where the following vehicle 204 moves toward the preceding vehicle 212 in search of fuel or energy benefit which is never realized.

With reference to FIG. 5A, the following vehicle 214 is following the preceding vehicle 212 with the ACC following distance set to distance FD_{5A}. The ACC following distance is perturbated to the distance FD_{5B} illustrated in FIG. 5B. At the following distance FD_{5B} a fuel or energy benefit evaluation is performed and, in this example, indicates a fuel or energy benefit has not been provided by the following distance FD_{5B}. One or more safety or operational limit evaluations may also be performed and, in this example, have not been reached or exceeded. In response to a determination of no fuel or energy benefit and a determination of no safety or operational limit being reached or exceeded, the ACC following distance is not modified but process 300 is permitted to continue and repeat perturbation.

At the following distance FD_{5B}, the perturbation process is repeated to provide following distance FD_{5C} illustrated in FIG. 5C. At the following distance FD_{5C} a fuel or energy benefit evaluation is again performed and, in this example, indicates a fuel or energy benefit has not been provided by the following distance FD_{5C}. One or more safety or operational limit evaluations may also be performed and, in this example, have not been reached or exceeded. In response to a determination of no fuel or energy benefit and a determination of no safety or operational limit being reached or exceeded, the ACC following distance is not modified but process 300 is permitted to continue and repeat perturbation.

At the following distance FD_{5C}, the perturbation process is repeated to provide following distance FD_{5D} illustrated in FIG. 5D. At the following distance FD_{5D} a fuel or energy benefit evaluation is again performed and, in this example, indicates a fuel or energy benefit has not been provided by the following distance FD_{5D}. In response to this determination, the ACC following distance is modified to return to the following distance FD_{5A} which is initial ACC following distance.

While exemplary embodiments of the disclosure have been illustrated and described in detail in the drawings and foregoing description, the same is to be considered as illustrative and not restrictive in character, it being understood that only certain exemplary embodiments have been illustrated and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of operating an adaptive cruise control system to control operation of a vehicle, the method comprising:
detecting a preceding vehicle in proximity to the vehicle;
controlling the vehicle to follow the preceding vehicle with an adaptive cruise control target following distance set at an initial following distance;
perturbating the adaptive cruise control target following distance to a perturbated following distance;
determining whether the perturbated following distance offers a fuel or energy benefit;
if the perturbated following distance offers a fuel or energy benefit, updating the adaptive cruise control target following distance to the perturbated following distance and operating the vehicle to follow the preceding vehicle with the updated adaptive cruise control target following distance; and
repeating the acts of perturbating and determining until one of a following distance limit and a perturbation limit is reached.

2. The method of claim 1 comprising:
if one of the following distance limit and the perturbation limit is reached, evaluating whether determination of a fuel or energy benefit has occurred; and
if determination of a fuel or energy benefit has not occurred, setting the adaptive cruise control target following distance to one of the initial following distance and a predetermined distance.

3. The method of claim 1 comprising:
evaluating whether a change in road grade during the acts of the acts of perturbating and determining exceeds a limit; and
if the change in road grade exceeds the limit, one of repeating the acts of perturbating and determining without setting the adaptive cruise control target following distance to the perturbated following distance regardless of whether the perturbated following distance provides a fuel or energy benefit, and compensating for an effect of the change in road grade when setting the adaptive cruise control target following distance.

4. The method of claim 1 wherein the acts of perturbating and determining are repeated every 5 seconds or less.

5. The method of claim 1 wherein the acts of perturbating and determining are repeated every 2 seconds or less.

6. The method of claim 1 wherein fuel or energy benefit is determined by comparing an average rate of change of a fuel or energy parameter at the current distance from a preceding vehicle relative to the a fuel or energy parameter at a prior distance from the preceding vehicle.

7. The method of claim 1 wherein at least one of (a) the vehicle does not receive any communication or information sent from the preceding vehicle, and (b) the adaptive cruise control system controls operation of a vehicle without using any communication or information sent from the preceding vehicle.

8. The method of claim 1 wherein the fuel or energy benefit comprises one or more of a decrease in fuel consumption, a decrease in energy consumption, an increase in fuel efficiency, and an increase in energy efficiency.

9. A system comprising:
a prime mover configured to propel a vehicle; and
an electronic control system operatively coupled with the prime mover and including a controller and one or more vehicle environment sensors, the electronic control system being configured to
detect a preceding vehicle in proximity to the vehicle in response to input from the one or more vehicle environment sensors,
control the prime mover to propel the vehicle to follow the preceding vehicle with an adaptive cruise control target following distance set at an initial following distance,
perturbate the adaptive cruise control target following distance to a perturbated following distance,
determine whether the perturbated following distance offers a fuel or energy benefit,
if the perturbated following distance offers a fuel or energy benefit, update the adaptive cruise control target following distance to the perturbated following distance and operate the vehicle to follow the preceding vehicle with the updated adaptive cruise control target following distance, and
repeat the perturbation of the adaptive cruise control target following distance and determination whether the perturbated following distance offers a fuel or energy benefit until a control limit condition is reached.

10. The system of claim 9 wherein the control limit condition comprises at least one of a following distance limit and a perturbation limit and the electronic control system is configured to
determine whether the following distance limit or the perturbation limit is reached,
determine whether a fuel or energy benefit has occurred if one of the following distance limit and the perturbation limit is reached, and
set the adaptive cruise control target following distance to one of the initial following distance and a predetermined distance if one of the following distance limit and the perturbation limit is not reached.

11. The system of claim 9 wherein the electronic control system is configured to
evaluate whether a change in road grade exceeds a limit; and
if the change in road grade exceeds the limit, one of (a) repeat the perturbation of the adaptive cruise control target following distance and determination whether the perturbated following distance offers a fuel or energy benefit without setting the adaptive cruise control target following distance to the perturbated following distance regardless of whether the perturbated following distance provides a fuel or energy benefit, and (b) compensate for an effect of the change in road grade when setting the adaptive cruise control target following distance.

12. The system of claim 9 wherein the electronic control system is configured to determine fuel or energy benefit by comparing an average rate of change of a fuel or energy parameter at the current distance from a preceding vehicle relative to the a fuel or energy parameter at a prior distance from the preceding vehicle.

13. The system of claim 9 wherein at least one of (a) the vehicle does not receive any communication or information sent from the preceding vehicle, and (b) the electronic control system controls operation of a vehicle without using any communication or information sent from the preceding vehicle.

14. The system of claim 9 wherein the fuel or energy benefit comprises at least one of a decrease in fuel consumption, a decrease in energy consumption, an increase in fuel efficiency, and an increase in energy efficiency.

15. An apparatus comprising:
one or more non-transitory memory media configured to store controller-executable instructions,
an electronic controller configured to receive input from one or more vehicle environment sensors and to control a prime mover configured to propel a vehicle by executing the controller-executable instructions;
wherein the controller-executable instructions include instructions to
detect a preceding vehicle in proximity to the vehicle in response to input received from the one or more vehicle environment sensors,
control the prime mover to propel the vehicle to follow the preceding vehicle with an adaptive cruise control target following distance set at an initial following distance,
perturbate the adaptive cruise control target following distance to a perturbated following distance,
determine whether the perturbated following distance offers a fuel or energy benefit,
if the perturbated following distance offers a fuel or energy benefit, update the adaptive cruise control target following distance to the perturbated following distance and provide a command to control the vehicle to follow the preceding vehicle with the updated adaptive cruise control target following distance,
determine whether a following distance limit or a perturbation limit is reached, and
repeat the perturbation of the adaptive cruise control target following distance and determination whether the perturbated following distance offers a fuel or energy benefit until a control limit condition is reached.

16. The apparatus of claim 9 wherein the control limit condition comprises at least one of a following distance limit and a perturbation limit and the controller-executable instructions include instructions to
determine whether the following distance limit or the perturbation limit is reached,
determine whether a fuel or energy benefit has occurred if one of the following distance limit and the perturbation limit is reached, and
set the adaptive cruise control target following distance to one of the initial following distance and a predetermined distance if one of the following distance limit and the perturbation limit is not reached.

17. The apparatus of claim 9 wherein the controller-executable instructions include instructions to
evaluate whether a change in road grade exceeds a limit; and
if the change in road grade exceeds the limit, one of (a) repeat the perturbation of the adaptive cruise control target following distance and determination whether the perturbated following distance offers a fuel or energy benefit without setting the adaptive cruise control target following distance to the perturbated following distance regardless of whether the perturbated following distance provides a fuel or energy benefit, and (b) compensate for an effect of the change in road grade when setting the adaptive cruise control target following distance.

18. The apparatus of claim 9 wherein the controller-executable instructions include instructions to determine fuel or energy benefit by comparing an average rate of change of a fuel or energy parameter at the current distance from a preceding vehicle relative to the a fuel or energy parameter at a prior distance from the preceding vehicle.

19. The apparatus of claim 9 wherein the controller-executable instructions include instructions to control operation of a vehicle without using any communication or information sent from the preceding vehicle.

20. The apparatus of claim 9 comprising the prime mover, the one or more vehicle environment sensors, and the vehicle.
